(19) United States
(12) Patent Application Publication
(10) Pub. No.: US 2006/0100888 A1
(43) Pub. Date: May 11, 2006

(54) System for managing identification information via internet and method of providing service using the same

(76) Inventors: Soo Hyung Kim, Daejeon-city (KR); Ki Young Moon, Daejeon-city (KR); Jong Soo Jang, Daejeon-city (KR); Sung Won Sohn, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/994,148

(22) Filed: Nov. 19, 2004

(30) Foreign Application Priority Data
Oct. 13, 2004 (KR) 2004-81890

(51) Int. Cl. G06Q 99/00

(52) U.S. Cl. 705/1

(57) ABSTRACT

The present invention relates to a system for managing user identity information via the Internet and a method of providing a service using the same. The identity information managing system including: an electronic identification certificate issuing device for issuing an electronic identification certificate to authenticate and secure a user identity on the Internet; a service providing device for preparing an electronic contract with a user on the basis of the electronic identification certificate of the user, and providing a service to the user; and a user-side server receiving the service from the service providing device with which the electronic contract with the user is prepared.

### BACKGROUND OF THE INVENTION

1. Field of the Invention

The present invention relates to a system for managing user identity information via the Internet and a method of providing a service using the same.

2. Description of the Related Art

The Internet is a current main media for a mutual transaction and communication of Business-to-Business (B2B), Business-to-Consumer (B2C), and Peer-to-Peer (P2P) in all fields of policy, culture and industry. Among actions using the Internet as media, the transaction of the B2C is being vigorously made above all things. However, most of actions made between the business and the customer on the non-face-to-face Internet have several limitations and drawbacks due to the absence of a mutual reliability. Since the business distrusts the customer, the business should install several safeguards for the service provided to the customer, requires much more identity information of the customer, and is burdened to safely manage the user identity information provided to the customer. Since the customer distrusts the business, the customer uses others' identity information (for example, resident registration number) by stealth that are necessary for a specific service (for example, adult service), avoids the service of the business that requires detailed identity information, and has a difficulty in eliminating an anxiety about whether or not the businesses rightly manages the user identity information.

A service provider's reliability on the customer is mainly based on the user identity information (resident registration number, name, mailing address, phone number, e-mailing address and the like), which the customer provides to the business. Accordingly, the business desires to secure the user identity information before it provides goods or services to the customer. Additionally, since the business cannot trust the user identity information, which is provided to the business through the Internet, the user identity information also contains a little more detailed information (credit card information, bank account information and the like), which cannot be accessed by others than the user. Further, in case where user identification is of absolute importance such as a bank affair, the business inputs the user identity information of the customer while directly facing the customer in off-line. Due to the absence of a technology of making the user identity information be reliable, the business does not have a suitable solution for preventing the users to unlawfully use the user identity information by stealth.

A user's reliability on the service provider is based on various evaluation standards on the service provider. As the evaluation standard, there are a business scale, a recognition level of the business, earlier users' evaluation on the goods and the services provided by the business, a quality level of a Web site provided by the business and the like. Most of the evaluation standards are determined depending on a subjective judgment of the customer. Accordingly, since a customer's reliability on the business is not based on a system, which can be guaranteed by a technology or a law, the customer have no choice but to provide considerably limited information to the business, and the customer cannot assure whether or not the business safely protect personal privacy. Further, it is difficult to prepare a basis of a responsibility and compensation for when personal information is unlawfully leaked outside.

In order to overcome the above drawbacks, two study courses are provided.

The one is a Platform for Privacy Preferences (P3P), which is a technological access for protecting the personal privacy. The other is a relating study of Federated Identity for providing a method of securing personal identity when the customer does transact with other businesses on the basis of a reliability previously built between the customer and the business.

The P3P provides a technological plan for allowing the users to judge by themselves whether or not how to protect their own personal information to any degree, and for examining errors or missing items of the privacy policy notified by the business. However, the P3P functions to determine whether or not a specific Web site observes the privacy policy, but does not provide a definite description as to whether or not how a system of the business protects the user identity information, and is not in consideration of a method of evaluating whether or not the user identity information provided by the user is right.

In the relating study of Federated Identity, the personal identity information is concentrated and managed at one place to prevent the personal identity information from being scattered over various businesses (or organizations). The customer's reliability on the services of other businesses is built by guaranteeing the business, which manages the personal identity information. For this guarantee, it is assumed that reliabilities are preceded and built between the businesses accessed by the user. An object of the relating study of Federated Identity is to provide a method of building an inter-business cooperation process, provide a function of a Single Sign-On (SSO) to provide a convenience to the user, and reduce a business cost required for managing the users. However, the Federated Identity relating study cannot solve a drawback relating to a misuse, which can be generated in the business, of the personal privacy, and has a limitation in that the reliabilities between the businesses should be previously built.

### SUMMARY OF THE INVENTION

Accordingly, the present invention is directed to a system for managing identification information via the Internet and a method of providing a service using the same, which substantially obviate one or more problems due to limitations and disadvantages of the related art.

It is an object of the present invention to provide a system for managing identification information via the Internet and a method of providing a service using the same, in which a service provider can easily and safely provide the service on the basis of a mutual reliability, which is built between a user and the service provider on the basis of user identity information so that the user can freely access the service even without an inconvenient authentication process, and in which the service provider is not allowed to misuse the user identity information.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an identity information managing system including: an electronic identification certificate issuing device for issuing an electronic identification certificate to authenticate and secure a user identity on the Internet; a service providing device for preparing an electronic contract with a user on the basis of the electronic identification certificate of the user, and providing a service to the user; and a user-side server receiving the service from the service providing device with which the electronic contract with the user is prepared.

In another aspect of the present invention, there is provided a method of providing a service using identity information on the Internet, the method including: a first step of issuing an electronic identification certificate to a user in an electronic identification certificate issuing device; a second step of, if the user provides the electronic identification certificate to request the service providing device for the service, preparing an electronic contract in the service providing device when the electronic contract with the user does not have ever been prepared; and a third step of, in case where the electronic contract is already prepared or is newly prepared, receiving the service from the service providing device.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a schematic view illustrating an electronic identification certificate according to the present invention;

FIG. 2 is a schematic view illustrating an electronic contract according to the present invention;

FIG. 3 is a view illustrating a construction of an identification information management system using the Internet according to the present invention;

FIG. 4 is a view illustrating a construction of an electronic identification certificate issuing device according to the present invention;

FIG. 5 is a view illustrating a construction of a service providing device according to the present invention;

FIG. 6 is a view illustrating a construction of a user-side server according to the present invention;

FIG. 7 is a flowchart schematically illustrating an electronic identification certificate issuing method according to the present invention;

FIG. 8 is a flowchart schematically illustrating a method of preparing an electronic contract between a user and a service providing device according to the present invention; and

FIG. 9 is a flowchart schematically illustrating a service supplying method of a service providing device according to the present invention.

### DETAILED DESCRIPTION OF THE INVENTION

Reference will now be made in detail to the preferred embodiments of the present invention, examples of which are illustrated in the accompanying drawings.

FIG. 1 is a schematic view illustrating an electronic identification certificate according to the present invention.

The electronic identification certificate includes a certificate unique number 11 for uniquely distinguishing the electronic identification certificate; a valid period 12 of the electronic identification certificate; and information 13 on an electronic identification certificate issuing device for issuing the electronic identification certificate.

The electronic identification certificate can additionally include user identity information 14. For example, the electronic identification certificate can include a user's real name, phone number, mailing address, resident registration number and the like. The electronic identification certificate can include information on a user-side server (Internet Protocol (IP) address, Uniform Resource Locator (URL) or the like) and the like. When the electronic identification certificate is issued, the electronic identification certificate can contain the user identity information 14 through user's selection or by using the electronic identification certificate issuing device. Since the electronic identification certificate can selectively include only necessary information to receive the service from a specific service providing device, the user can receive and manage a plurality of issued electronic identification certificates through the user-side server. In other words, the user can use the electronic identification certificate not containing the user identity information in order to participate in an Internet community not needing security maintenance. In order to access adult contents, the user can use the electronic identification certificate containing his/her age.

The electronic identification certificate according to the present invention can additionally include user-side server information 15. The user-side server information 15 can be information such as the IP or the URL of the user-side server. The electronic identification certificate can be restricted and used only in the user-side server determined by the user-side server information 15.

The electronic identification certificate according to the present invention can additionally include adult authentication information 16. The adult authentication information 16 is provided by confirming the user identity information (for example, real name and resident registration number) in the electronic identification certificate issuing device. The adult authentication information 16 allows adult authentication without exposing the user's real name and resident registration number to the service providing device.

The electronic identification certificate according to the present invention can additionally include a digital signature 17 of the electronic identification certificate issuing device to secure an integrity of the electronic identification certificate.

The electronic identification certificate can be preferably embodied as an extensible Markup Language (XML) document, but is not limited to this.

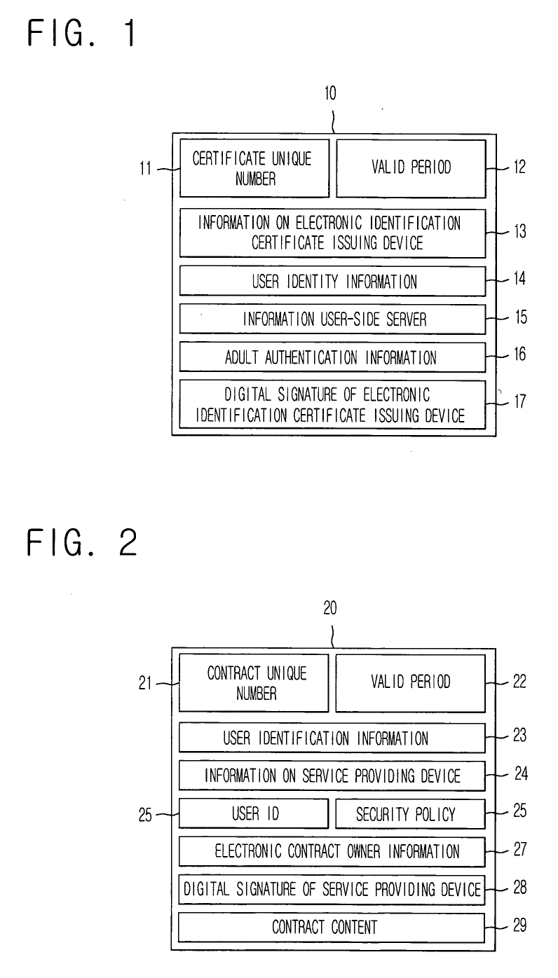

FIG. 2 is a schematic view illustrating an electronic contract according to the present invention.

The electronic contract 20 includes a contract unique number 21 for uniquely distinguishing the electronic contract prepared by the service providing device; a valid period 22 of the electronic contract; the user identity information 23 provided by the user to the service providing device when the electronic contract is prepared; and information 24 on the service providing device for preparing the electronic contract. Further, the electronic contract 20 can additionally include a user Identification (ID) 25 for uniquely distinguishing the user within the service providing device concluding the electronic contract; a security policy 26 for describing a privacy policy, which is provided to the user, of the service providing device or a range of a service, which can be used by the user in a service providing device system; an electronic contract owner information 27 for authenticating an owner of the electronic contract; a digital signature 28 of the service providing device for securing a validness of the electronic contract; and a contract content 29 negotiated and determined by the user and the service providing device at the time of the preparation of the electronic contract.

The privacy policy recorded in the security policy 26 can be differently applied depending on the user. For example, as personal identification information provided by the user, a personal information collecting method and personal information range permitted by the user, and a personal information processing range permitted by the user are large, the security policy 26 is determined to allow the service providing device to provide a little more service to the user.

The electronic contract owner information 27 is to certify that the user has ever prepared the electronic contract with the service providing device. As long as information certifies the fact that the user concludes the electronic contract, the information is not limited in type and method. For example, that the user previously owns the electronic contract concluded with the service providing device is certified through the following processes. First, a symmetric key that only the user and the service providing device identify is provided as owner authenticating information, and then the service providing device transmits an arbitrarily created character string to the user-side server. After that, the user-side server encrypts through the symmetric key a result of Hash function, which has the arbitrary character string and the concluded electronic contract as inputs, and then the user-side server transmits the encrypted character string to the service providing device. Next, the service providing device encrypts through the symmetric key a result of Hash function, which has the arbitrary character string and the concluded electronic contract as inputs, and then it is determined whether or not the encrypted character string is matched with the character string transmitted by the user-side server. The electronic contract owner information 27 prevents a man-in-the-middle attack, a reply attack or the like.

The service providing device information 24 can include information for grasping a reliability of the service providing device. For example, the service providing device information 24 can include evaluation information of a shopping-mall reliability performed by a trusted third party. The evaluation information substitutes a shopping-mall certifying mark of an electronic commercial transaction certifying system executed in a domestic country.

The electronic contract includes the digital signature 28 prepared by the service providing device so as to secure an integrity and a compulsion of the electronic contract. This acts as a basis of forcing a contract execution or claiming a breach of contract damages in case where the service providing device violates the privacy policy and other contract items of the electronic contract.

The electronic contract can be preferably embodied as the extensible Markup Language (XML) document, but is not limited to this.

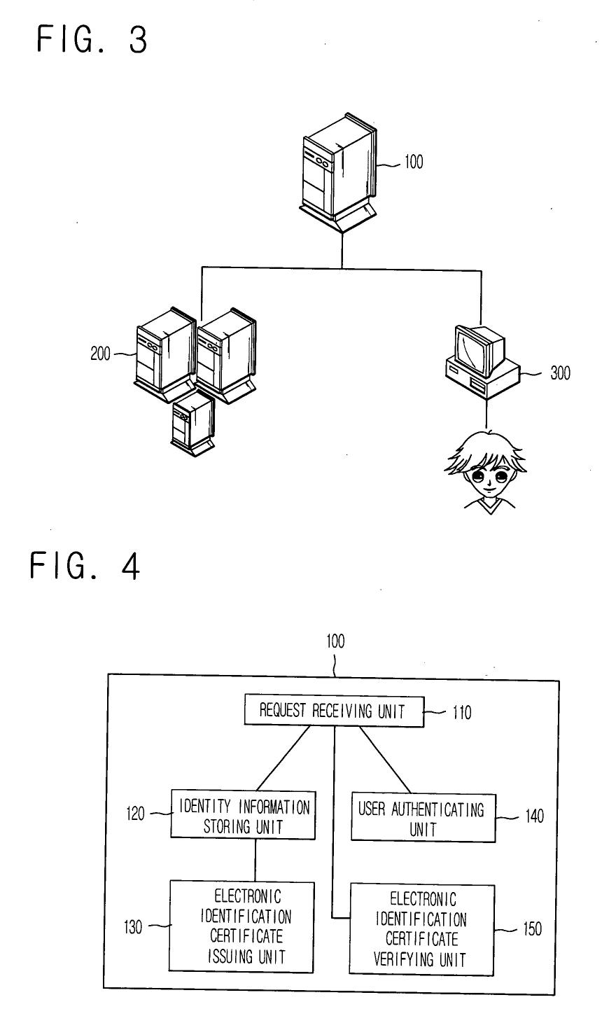

FIG. 3 is a view illustrating a construction of an identification information management system using the Internet according to the present invention.

In case where the user-side server requests an issuance of the electronic identification certificate, the electronic identification certificate issuing device 100 receives the user identity information to issue the electronic identification certificate. The electronic identification certificate is transmitted from the user-side server 300 to the service providing device 200. The service providing device 200 uses the electronic identification certificate to prepare the electronic contract with the user. The service providing device 200 decides a range of the service to be provided to the user, on the basis of the concluded electronic contract. Additionally, the service providing device 200 protects the user identity information on the basis of the contract content of the concluded electronic contract, and provides the service to the user before until the valid period of the electronic contract is terminated. The user-side server 300 receives and stores the electronic identification certificate issued from the electronic identification certificate issuing device 100, provides the electronic identification certificate to the service providing device 200 to prepare the electronic contract, and accesses the service providing device 200 to receive the service from the service providing device 200 with which the electronic contract is prepared. In addition, the user-side server 300 manages a list of a plurality of electronic identification certificates issued to the user and a plurality of electronic contracts concluded with a plurality of service providing devices 200, and prepares and manages an access record in which the user accesses the service providing device 200 to have the service.

The electronic identification certificate issuing device 100 is connected to the Internet, and issues the electronic identification certificate in response to a user' request for the issuance of the electronic identification certificate using the user-side server 300 to transmit the issued electronic identification certificate to the user-side serer 300. The electronic identification certificate issuing device 100 can be preferably managed by an organization with a source credibility so as to secure the reliability of the electronic identification certificate. Further, in case where the present invention is limitedly applied to a specific area or group, the electronic identification certificate issuing device 100 can be managed by a corresponding private organization. The electronic identification certificate issuing device 100 can be understood to correspond to a public certification organization or a private certification organization in a Public Key Infrastructure (PKI). The electronic identification certificate issuing device 100 receives and records the user identity information (non-modified user identity information, for example, real name and resident registration number) only at one and initial time so as to issue the electronic identification certificate. At this time, the electronic identification certificate issuing device 100 preferably receives the user identity information by using means for guaranteeing the user identity, that is, a public certificate or a private certificate. The user cannot directly modify the user identity information to secure the reliability of the user identity information.

The service providing device 200 provides the service such as a service that can be provided via the Internet, to the user. The service providing device 200 can include a web server, an application server or the like for a variety of services, which can be provided via the Internet.

The user-side server 300 is connected to the Internet, and can be embodied as a personal computer, a home server for a digital home, a set-top box or the like. The user-side server 300 is limited to allow only a specific user to use the user-side server 300 and have the electronic identification certificate issued from the electronic identification certificate issuing device 100, and to use the electronic identification certificate and have the service from the service providing device 200. Preferably, the user-side server 300 is managed to allow a restricted access of only a single user, but is not restricted to allow accesses of a plurality of users. In case where the user intends to access the user-side server 300, the user-side server 300 confirms user's security information to perform a user authentication. The security information is to confirm the user of the user-side server. The security information corresponds to an IDentification (ID), a password, a certificate, personal information recorded in a smart card, and the like. The user can even directly manipulate the user-side server 300, but also can remotely access and manipulate the user-side server 300 by using a terminal such as a separate personal computer, a Portable Digital Assistant (PDA), a mobile phone and the like.

FIG. 4 is a view illustrating a construction of the electronic identification certificate issuing device 100 according to the present invention.

The electronic identification certificate issuing device 100 includes a service request receiving unit 110 for functioning as a window through which the electronic identification certificate is issued; an identity information storing unit 120 for storing the user identity information; an electronic identification certificate issuing unit 130 for issuing the electronic identification certificate on the basis of the recorded personal information according to a user's request; a user authenticating unit 140 for authenticating the user when the user requests the electronic identification certificate issuing unit for the service; and an electronic identification certificate verifying unit 150 for verifying whether or not the electronic identification certificate is valid when the service providing device 200 is requested to verify the electronic identification certificate of the specific user.

The request receiving unit 110 functions as the window to issue the electronic identification certificates for a plurality of users. Preferably, the request receiving unit 110 provides a Webpage, which can directly interact with the user, and interacts with the user-side server 300 or the service providing device 200 through an Internet protocol when the electronic identification certificate is issued or verified.

In case where the user initially connects to the electronic identification certificate issuing device 100, that is, in case where the user identity information is not stored in the identity information storing unit 120, the identity information storing unit 120 receives and records the user identity information. In case where the user identity information is already recorded, the identity information storing unit 120 transmits the user identity information to the electronic identification certificate issuing unit 130 to allow the issuance of the electronic identification certificate. Since a credibility of the user identity information is of much importance, the stored user identity information is received and recorded using the public certificate or other person-authenticating units.

The electronic identification certificate issuing unit 130 receives the user identity information from the identity information storing unit 120 to prepare and transmit the electronic identification certificate to the user-side server 300 through the request receiving unit 110.

The electronic identification certificate includes the certificate unique number for uniquely distinguishing the electronic identification certificate, the valid period of the electronic identification certificate, and information on the electronic identification certificate issuing device for issuing the electronic identification certificate. A newly assigned certificate unique number is transmitted to the electronic identification certificate verifying unit 150 and is used to verify as to whether or not the electronic identification certificate is valid.

If the service request receiving unit 110 transmits the electronic identification certificate received from the service providing device 200, the electronic identification certificate verifying unit 150 verifies as to whether or not the electronic identification certificate is valid. For example, the certificate unique number and the information on the electronic identification certificate issuing device can be confirmed to determine whether or not the electronic identification certificate is valid.

The electronic identification certificate issuing device 100 can include functions and units of a general server though they are not illustrated in the drawings.

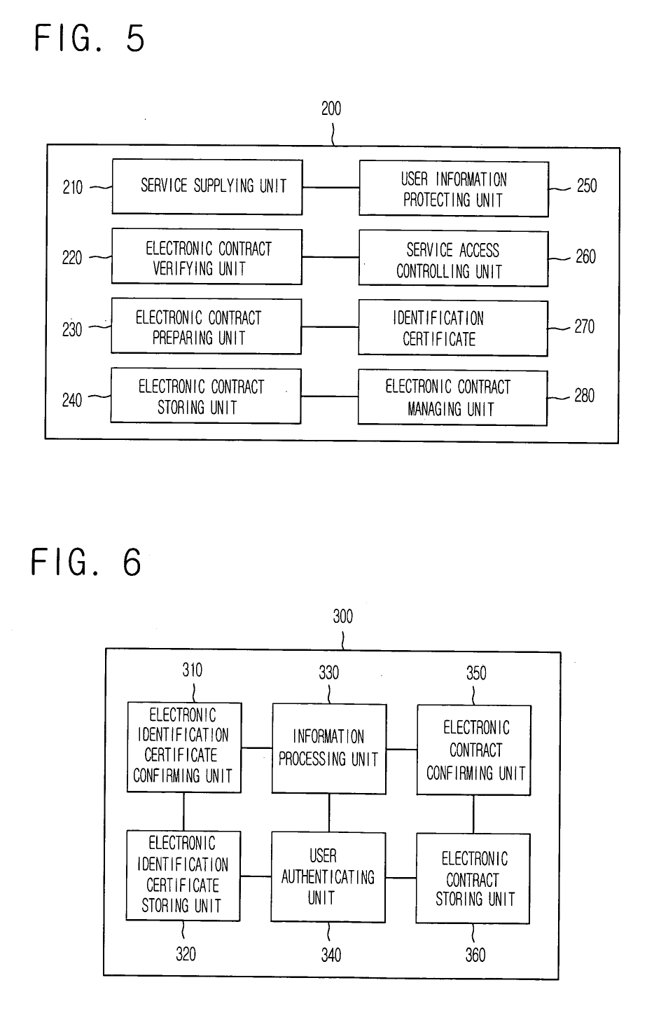

FIG. 5 is a view illustrating a construction of the service providing device 200 according to the present invention.

The service providing device 200 includes a service supplying unit 210 for supplying goods and services to the user; an electronic contract verifying unit 220 for verifying the electronic contract provided by the user; an electronic contract preparing unit 230 for preparing the electronic contract for the user with whom the electronic contract is not prepared; an electronic contract storing unit 240 for storing the prepared electronic contract; a user information protecting unit 250 for protecting the user identity information on the basis of the electronic contract; a service access controlling unit 260 for determining a service range for the user on the basis of the electronic contract; an electronic identification certificate confirming unit 270 for confirming whether or not the electronic identification certificate provided by the user is valid when the electronic contract is prepared; and an electronic contract managing unit 280 for managing the electronic contract according to the content of the electronic contract and the policy of the service providing device.

The service supplying unit 210 provides the service through the Internet to the user with whom the electronic contract is prepared. The service of the service supplying unit 210 is not limited in type or content as long as the service can be provided via the Internet. In case where the user requests the service, the service supplying unit 210 searches for the electronic contract storing unit 240 to determine whether or not the electronic contract is prepared. As a result of determination, if it is determined that the valid electronic contract exists, the service supplying unit 210 provides the service. If it is determined that the valid electronic contract is absent, the service supplying unit 210 requests the user-side server 300 for the electronic identification certificate, and instructs the electronic identification certificate confirming unit 270 and the electronic contract preparing unit 230 to prepare the electronic contract.

The user information protecting unit 250 confirms whether or not the service supplying unit 210 observes a protection standard on the user identity information of the service providing device 200. The protection standard is mentioned in the electronic contract. For example, in case where the service supplying unit 210 executes a customer relationship management marketing for the user on the basis of the item contained in the electronic contract and user's access and use careers on the service providing device 200, the user information protecting unit 250 can determine whether or not a utilization of user's career information violates the protection standard, which is mentioned in the electronic contract. Further, even in case where the service supplying unit 210 collects a user's service use career, the user information protecting unit 250 can determine whether or not the collecting of the user's service use career violates the protection standard on the user identity information.

The service access controlling unit 260 restricts or allows the service depending on the user. For example, the service access controlling unit 260 can restrict or allow the service to be provided to the user, depending on a degree of the user identity information contained in the electronic contract or depending on the range of the service contained in the electronic contract. In other words, in case where the electronic contract allows a user's access authority only for a specific service, the service access controlling unit 260 does not allow remaining services or can determine whether or not the adult contents may be provided on the basis of a user's age.

The electronic identification certificate confirming unit 270 confirms the electronic identification certificate provided from the user-side server 300, for the preparation of the electronic contract. In case where the electronic identification certificate is valid, the electronic identification certificate confirming unit 270 extracts the user identity information and other information, which are contained in the electronic identification certificate, to transmit the extracted information to the electronic contract preparing unit 230. In order to confirm the validness of the electronic identification certificate, a different method can be employed depending on a required degree of accuracy. For example, there is a method in which only a format of the resident registration number is verified, or in which the electronic identification certificate is transmitted to the electronic identification certificate verifying unit 150 to verify as to whether or not the electronic identification certificate is valid.

Besides, the service providing device 200 can include functions and units of the general server, and can additionally include accompanying structural elements that are required for a variety of services though they are not illustrated in the drawings.

FIG. 6 is a view illustrating a construction of the user-side server 300 according to the present invention.

The user-side server 300 includes an electronic identification certificate confirming unit 310 for confirming the validness of the electronic identification certificate, which is issued from the electronic identification certificate issuing device; an electronic identification certificate storing unit 320 for storing and managing the issued electronic identification certificate; an information processing unit 330 for providing information relating to the electronic identification certificate and the electronic contract, to the user; a user authenticating unit 340 for confirming a use subject of the user-side server; an electronic contract confirming unit 350 for confirming the validness of the electronic contract prepared by the service providing device; and an electronic contract storing unit 360 for storing and managing the electronic contract prepared by the service providing device.

The information processing unit 330 is connected to the Internet, and processes a variety of requests received at the user-side server 300 through the Internet to provide a result value of the processed requests. In other words, in case where the user connects to the user-side server 300, the information processing unit 330 authenticates the user through the user authenticating unit 340. When the information relating to the electronic identification certificate or the electronic contract is requested for perusal, the information processing unit 330 searches and provides information stored in the electronic identification certificate storing unit 320 or the electronic contract storing unit 360. Further, in case where the electronic identification certificate issuing device 100 issues the electronic identification certificate to the user, the electronic identification certificate confirming unit 310 confirms the validness of the issued electronic identification certificate, and stores the confirmed electronic identification certificate in the electronic identification certificate storing unit 320. In case where the user intends to receive the service from the service providing device 200 and the service providing device 200 does not have the valid electronic contract, the information processing unit 330 transmits the stored electronic identification certificate to the service providing device 200 according to the request of the service providing device 200. The service providing device 200 issues the electronic contract to the information processing unit 330. Accordingly, the electronic contract confirming unit 350 is allowed to confirm the validness of the electronic contract, and then store the confirmed electronic contract in the electronic contract storing unit 360. Furthermore, the information processing unit 330 performs a career management such as a user's issuance career management for the electronic identification certificate, a connection career management for the service providing device, and the like. The information processing unit 330 can create a security communication channel (for example, Secure Sockets Layer (SSL)/Transport Layer Security (TLS)) to communicate with the electronic identification certificate issuing device 100 or the service providing device 200 for the security maintenance. Further, in case where the user remotely connects to the user-side server 300 through the terminal such as the personal computer, the PDA, the mobile phone and the like, the information processing unit 330 can also allow the access only to a specific position or a specific unit. For example, the information processing unit 330 can limitedly allow only the connected user or the terminal user, which has a designated Internet Protocol (IP) address in a local network, to connect to the user-side server 300 for use.

The user authenticating unit 340 authenticates the use subject of the user-side server 300. In case where the user accesses the user-side server 300, the information processing unit 330 requests the user authenticating unit 340 for the user authentication. At this time, the user authenticating unit 340 requests user's security information to authenticate the user and allows only the authenticated user to access the user-side server 300. The user authentication can be performed using ways such as the inputting of the IDentification (ID) and the password, the certification using the public certificate, or the certification using a smart card of the user, but is not limited to these.

Besides, the user-side server can include structural elements of the general server though they are not illustrated in the drawings.

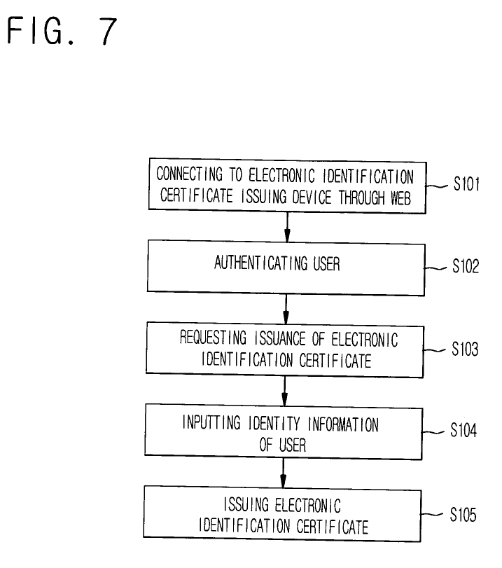

FIG. 7 is a flowchart schematically illustrating an electronic identification certificate issuing method according to the present invention.

First, the user connects to the electronic identification certificate issuing device 100 through Web Browser (S101). The connected user provides the security information for the user authentication (S12). If the user authentication fails, the electronic identification certificate issuing device 100 denies the access of the user. If the authenticated user requests the issuance of the electronic identification certificate through the service request receiving unit 110 of the electronic identification certificate issuing device 100 (S103), the electronic identification certificate issuing device 100 requests an input of the user identity information, which is required for the issuance of the electronic identification certificate. In response to the request, the user inputs the required user identity information (S104). At this time, information overlapped with the user identity information inputted at the time of the initially registering of the user can be omitted. For example, since the user identity information such as the user's name, resident registration number and the like inputted at the time of the registering of the user is known, the user identity information need not be again inputted to the electronic identification certificate issuing device 100. The electronic identification certificate issuing device 100 creates the electronic identification certificate by using the inputted user identity information. At this time, basic information such as the user's name, resident registration number and the like may not be contained in the electronic identification certificate according to the user's request when anonymity is required. Additionally, before or after the issuance of the electronic identification certificate, the electronic identification certificate issuing device 100 can also allow the user to confirm the contents of the electronic identification certificate through Web Browser. The electronic identification certificate issuing device 100 transmits the issued electronic identification certificate to the user-side server, and allows the user-side server to verify and store the issued electronic identification certificate, thereby completing the issuance of the electronic identification certificate (S105).

In a method of issuing the electronic identification certificate, a communication between the user and the electronic identification certificate issuing device and a communication between the electronic identification certificate issuing device and the user-side server are preferably performed over the SSL/TLS channel for the security maintenance.

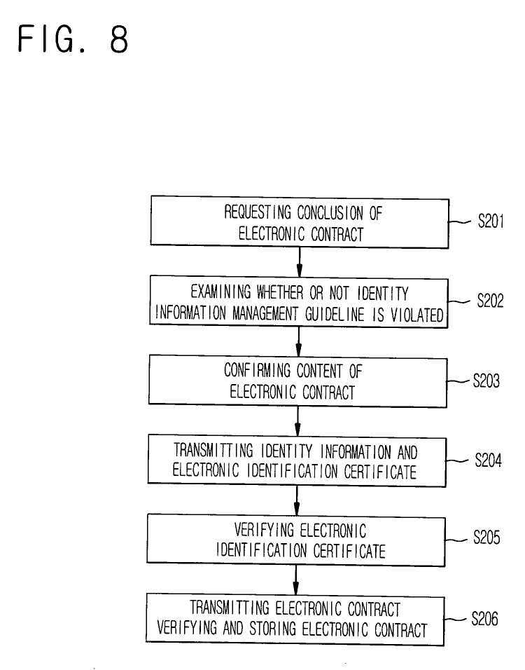

FIG. 8 is a flowchart schematically illustrating a method of preparing the electronic contract between the user and the service providing device according to the present invention.

A service requesting unit transmits the contract content to be contained in the electronic contract through the user-side server and at the same time, requests the conclusion of the electronic contract in such a manner that the electronic identification certificate and the user identity information required at the time of the preparation of the electronic contract are requested (S201). The user-side server determines whether or not the privacy policy, which is contained in the transmitted contract content, of the service providing device violates an identity information management guideline (S202). In case where the privacy policy does not violate the identity information management guideline as the determination result of the user-side server, the user-side server displays the transmitted content of the electronic contract on Web Browser to inform the user of the contract content, and provides an input window through which the user identity information required for the preparation of the electronic contract is inputted. The user confirms the content of the electronic contract (S203). And then, the user agrees to the conclusion of the electronic contract to select the electronic identification certificate, and inputs additional user identity information (for example, reception or not of e-mailing service provided from the service provider, an interested field, a marital status and the like) not contained in the electronic identification certificate. The user-side server transmits the received identity information and the selected electronic identification certificate to the service providing device (S204). The service providing device verifies the electronic identification certificate (S205), and prepares and signs the electronic contract matched with a contract request (S206). The service providing device transmits the prepared electronic contract to the user-side server (S207). The user-side server verifies whether or not the transmitted content of the electronic contract is matched with the contract content, which is provided when the conclusion of the electronic contract is requested, and whether or not the signature of the service providing device is accurately authenticated. If it is verified that the electronic contract is validly prepared, the user-side server stores the electronic contract (S208).

The user-side server automatically examines the privacy policy of the service providing device on the basis of the identity information management guideline previously defined by the user (S202) because the user cannot examine all contents of the privacy policy due to the vastness or the complexity of the privacy policy. In other words, the identity information management guideline has a degree of publication or an allowance degree of utilization for the user identity information. The degrees are previously defined by the user. In case where the privacy policy is against the previously defined identity information management guideline, the user-side server denies the conclusion of the electronic contract or notifies the user of the items, which are against the identity information management guideline.

In the method of preparing the electronic contract between the user and the service providing device, the communication between the service providing device and the user-side server is preferably performed over the SSL/TLS channel for the security maintenance.

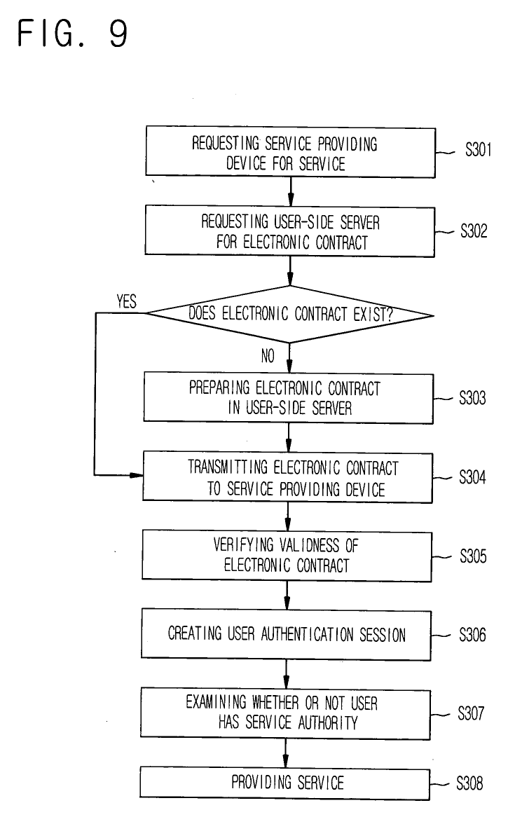

FIG. 9 is a flowchart schematically illustrating a service supplying method of the service providing device according to the present invention.

The user connects to the service providing device through Web Browser to request the service (S301). At this time, the service providing device requests the electronic contract from the user-side server (S302). In case where the user-side server searches for the electronic contract and determines that the valid electronic contract is absent, the user-side server notifies the service providing device of the absence of the valid electronic contract, and the electronic contract is prepared according to the method of preparing the electronic contract between the user and the service providing device (S303). In case where the valid electronic contract exists, the user-side server transmits the electronic contract to the service providing device (S304), and the service providing device verifies the validness of the electronic contract (S305). In case where the service providing device confirms that the electronic contract is valid, that is, in case where the service providing device receives the valid electronic contract from the user-side server or newly prepares the electronic contract, the service providing device creates a user authentication session according to need (S306). During the authentication session, as long as Web Browser in use is driven, the service can be provided to the user without confirming the electronic contract. In other words, during the authentication session, a service authority determining step (S307) can be performed just after the service requesting step (S301). If the user is authenticated, the service providing device determines whether or not the user has the authority for the requested service. In case where the service cannot be provided due to the fact that the user does not have the service authority, that is, due to the fact that the electronic contract does not contain the authority for the specific service, the service is denied. In case where the user has the service authority, the service requested by the user is provided (S308).

In the step where the service providing device requests the user-side server for the electronic contract (S302), the service providing device confirms a position of the user-side server in such manners that the user directly inputs the server position, that a previously registered position of the user-side server is ensured using the user ID inputted to the service providing device by the user, and that the user transmits a request message with the server position in Web Browser when the service is requested.

In behalf of the steps where the user-side server transmits the electronic contract to the service providing device to confirm the transmitted electronic contract (S304 and S3.05), the user-side server can transmit and confirm the authentication information of the owner of the electronic contract.

In the service supplying method of the service providing device according to the present invention, the communication between the service providing device and the user-side server is preferably performed over the SSL/TLS channel.

As described above, the present invention provides the method and device in which the user identity information is managed on the wire/wireless Internet, and the electronic contract between the service provider and the user is prepared on the basis of the user identity information to facilitate the provision of the service.

The present invention has a great effect in that the user identity information provided to the service provider can be prevented from being misused or unlawfully distributed, and an unlawful act of using other identity information by stealth can be fundamentally prevented owing to the reliability of the user identity information.

Further, the present invention has a great effect of replacing conventional inconvenient processes such as a member subscription, the inputting of the ID and the password, a member session and the like, which are previously performed by the user to provide the service through the Internet, to more safely and easily provide the Internet service.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An electronic identification certificate comprising:
a certificate unique number for uniquely distinguishing the electronic identification certificate;
a certificate valid period for determining a period for which the electronic identification certificate can be validly used;
information on an electronic identification certificate issuing device for issuing the electronic identification certificate;
user identity information; and
information on a user-side server using the electronic identification certificate.

2. The certificate of claim 1, further comprising adult authentication information for the user.

3. The certificate of claim 1, further comprising a digital signature of the electronic identification certificate issuing device.

4. An electronic contract comprising:
a contract unique number for uniquely distinguishing the electronic contracts prepared by a service providing device;
a contract valid period for determining a period for which the electronic contract can be validly used;
user identity information provided by a user to the service providing device when the electronic contract is prepared;
information on the service providing device with which the electronic contract is prepared;
a user ID (IDentification) for uniquely distinguishing the user in the service providing device with which the electronic contract is concluded;
a privacy policy of the service providing device, or a security policy describing a range of a service, which can be used by the user in a service providing device system; and
a contract content negotiated and determined between the user and the service providing device when the electronic contract is prepared.

5. The electronic contract of claim 4, further comprising electronic contract owner information for authenticating an owner of the electronic contract.

6. The electronic contract of claim 4, further comprising a digital signature of the service providing device to secure a validness of the electronic contract.

7. An identity information managing system comprising:
an electronic identification certificate issuing device for issuing an electronic identification certificate to authenticate and secure a user identity on the Internet;
a service providing device for preparing an electronic contract with a user on the basis of the electronic identification certificate of the user, and providing a service to the user; and
a user-side server receiving the service from the service providing device with which the electronic contract with the user is prepared.

8. The system of claim 7, wherein the electronic identification certificate issuing device comprises:
a request receiving unit for receiving a user's issuance request of the electronic identification certificate;
an identity information storing unit for storing user identity information;
an electronic identification certificate issuing unit for issuing the electronic identification certificate on the basis of the stored identity information according to the user's issuance request;
a user authenticating unit for authenticating the user when the user requests the electronic identification certificate issuing device for the service; and
an electronic identification certificate verifying unit for verifying whether or not the electronic identification certificate is valid when a verification request for the electronic identification certificate is received from the service providing device.

9. The system of claim 7, wherein the service providing device comprises:
a service supplying unit for providing goods and services to the user;
an electronic contract verifying unit for verifying the electronic contract provided from the user;
an electronic contract preparing unit for preparing the electronic contract with the user with whom the electronic contract is not prepared;
an electronic contract storing unit for storing the prepared electronic contract;
a user information protecting unit for protecting user identity information on the basis of the electronic contract;
a service access controlling unit for determining a service range for the user on the basis of the electronic contract;
an electronic identification certificate confirming unit for confirming a validness of the electronic identification certificate provided from the user at the time of preparing the electronic contract; and
an electronic contract managing unit for managing the electronic contract depending on a content contained in the electronic contract and a policy of the service providing device.

10. The system of claim 7, wherein the user-side server comprises:
an electronic identification certificate confirming unit for confirming the validness of the electronic identification certificate issued from the electronic identification certificate issuing device;
an electronic identification certificate storing unit for storing and managing the electronic identification certificate issued from the electronic identification certificate issuing device;
an information processing unit for providing the user with information relating to the electronic identification certificate and the electronic contract;
a user authenticating unit for confirming a use subject of the user-side server;
an electronic contract confirming unit for confirming the validness of the electronic contract prepared in the service providing unit; and
an electronic contract storing unit for storing and managing the electronic contract prepared in the service providing unit.

11. A method of providing a service using identity information on the Internet, the method comprising:
a first step of issuing an electronic identification certificate to a user in an electronic identification certificate issuing device;
a second step of, if the user provides the electronic identification certificate to request the service providing device for the service, preparing an electronic contract in the service providing device when the electronic contract with the user does not have ever been prepared; and
a third step of, in case where the electronic contract is already prepared or is newly prepared, receiving the service from the service providing device.

12. The method of claim 11, wherein the first step comprises the steps of:
connecting to the electronic identification certificate issuing device through Web browser;
providing security information to authenticate the user;
in case where the user is normally authenticated, inputting user identity information necessary for the issuance of the electronic identification certificate; and
transmitting the electronic identification certificate to a user-side server.

13. The method of claim 11, wherein the second step comprises the steps of:
transmitting to the user-side server a contract content to be contained in the electronic contract having a privacy policy, and requesting the electronic identification certificate and the user identity information, which are necessary for the preparation of the electronic contract;
determining whether or not the privacy policy of the service providing device violates a user identity information management guideline;
in case where the privacy policy does not violate the identity information management guideline, transmitting the user identity information and the electronic identification certificate;
verifying the electronic identification certificate in the service providing device to which the user identity information is transmitted, and preparing and signing the electronic contract; and
transmitting the prepared electronic contract to the user-side server.

14. The method of claim 11, wherein the third step comprises the steps of:
transmitting the electronic contract to the service providing device;
verifying the validness of the transmitted electronic contract;
in case where the electronic contract is valid, authenticating the user;
analyzing the electronic contract to determine whether or not the authenticated user has an authority for the requested service; and
in case where the authenticated user has the service authority, providing the service requested by the authenticated user.
